(19) United States
(12) Patent Application Publication
(10) Pub. No.: US 2014/0070524 A1
(43) Pub. Date: Mar. 13, 2014

(54) Coloring Book for Heat Transfer Sheets and Methods of Transferring an Image to a Substrate

(71) Applicant: Vanessa Sofia Ruiz de Vinaspre, Atlanta, GA (US)

(72) Inventor: Vanessa Sofia Ruiz de Vinaspre, Atlanta, GA (US)

(73) Assignee: NEENAH PAPER, INC., Alpharetta, GA (US)

(21) Appl. No.: 13/614,370

(22) Filed: Sep. 13, 2012

(51) Int. Cl. B32B 37/02; B42D 15/00

(52) U.S. Cl. 281/38; 156/62

(57) ABSTRACT

Methods for transferring an image to a substrate are provided. An image can be applied onto an image-receptive coating of a heat transfer sheet. The heat transfer sheet can further include a heat transfer layer overlying a base sheet such that the image-receptive coating overlies the heat transfer layer. The heat transfer sheet can be torn substantially along a perforation line to remove the heat transfer sheet from a coloring book, and then positioned adjacent to a substrate. The image, the image-receptive coating, and at least a portion of the heat transfer layer can then be transferred to the substrate, with the base sheet not transferring to the substrate. Coloring books are also provided that include a plurality of heat transfer sheets bound together along a common edge.

### BACKGROUND

In recent years, a significant industry has developed which involves the application of customer-selected designs, messages, illustrations, and the like (referred to collectively hereinafter as “images”) on articles, such as T shirts, sweat shirts, leather goods, and the like. These images may be commercially available products tailored for a specific end-use and printed on a release or transfer paper, or the customer may generate the images on a heat transfer paper. The images are transferred to the article by means of heat and pressure, after which the release or transfer paper is removed.

Graphic images are produced on the transferable surface or coating of the heat transfer paper by a printer/copier machine (e.g., an ink-jet printer, a laser-color copier, other toner-based printers and copiers, and so forth). The image and the transferable surface are then transferred to a substrate such as, for example, a cotton T-shirt.

It would be desirable, however, to have a way to provide a method and system for transferring hand-drawn images to a substrate.

### SUMMARY

Objects and advantages of the invention will be set forth in part in the following description, or may be obvious from the description, or may be learned through practice of the invention.

Methods are generally provided for transferring an image to a substrate. In one embodiment, an image can be applied onto an image-receptive coating of a heat transfer sheet. The heat transfer sheet can further include a heat transfer layer overlying a base sheet such that the image-receptive coating overlies the heat transfer layer. The heat transfer sheet can be torn substantially along a perforation line to remove the heat transfer sheet from a coloring book, and then positioned adjacent to a substrate. The image, the image-receptive coating, and at least a portion of the heat transfer layer can then be transferred to the substrate, with the base sheet not transferring to the substrate.

Coloring books are also generally provided that include a plurality of heat transfer sheets bound together along a common edge. Each heat transfer sheet can define a perforation line proximate to the common edge, and can include a base sheet, a heat transfer layer on the base sheet, and an image-receptive coating on the heat transfer layer. The image-receptive coating and at least a portion of the heat transfer layer are configured to transfer to a substrate upon application of heat and pressure.

Other features and aspects of the present invention are discussed in greater detail below.

### BRIEF DESCRIPTION OF THE DRAWINGS

A full and enabling disclosure of the present invention, including the best mode thereof to one skilled in the art, is set forth more particularly in the remainder of the specification, which includes reference to the accompanying figures, in which:

FIG. 1 shows an exemplary coloring book including a plurality of heat transfer sheets according to one embodiment of the present invention;

FIG. 2 shows a user manually applying an image onto a heat transfer sheet of the exemplary coloring book shown in FIG. 1;

FIG. 3 shows the imaged heat transfer sheet of FIG. 2 being removed from the exemplary coloring book;

FIG. 4 shows a cross-sectional view of an exemplary heat transfer sheet made in accordance with the present invention;

FIGS. 5-7 sequentially show an exemplary method of transferring an image to a substrate using the heat transfer sheet of FIG. 4;

FIG. 8 shows a cross-sectional view of another exemplary heat transfer sheet made in accordance with the present invention; and

FIGS. 9-11 sequentially show an exemplary method of transferring an image to a substrate using the heat transfer sheet of FIG. 8.

Repeat use of reference characters in the present specification and drawings is intended to represent the same or analogous features or elements of the present invention.

### DETAILED DESCRIPTION

Reference now will be made to the embodiments of the invention, one or more examples of which are set forth below. Each example is provided by way of an explanation of the invention, not as a limitation of the invention. in fact, it will be apparent to those skilled in the art that various modifications and variations can be made in the invention without departing from the scope or spirit of the invention. For instance, features illustrated or described as one embodiment can be used on another embodiment to yield still a further embodiment. Thus, it is intended that the present invention cover such modifications and variations as come within the scope of the appended claims and their equivalents. It is to be understood by one of ordinary skill in the art that the present discussion is a description of exemplary embodiments only, and is not intended as limiting the broader aspects of the present invention, which broader aspects are embodied exemplary constructions.

Coloring books including a plurality of heat transfer sheets are generally disclosed, along with methods of their use. The coloring books allow for a user to manually apply an image to an individual heat transfer sheet. For example, the image can be manually drawn onto an image-receptive coating of the heat transfer sheet by the user using a crayon (e.g., comprising a colored wax), a pencil (e.g., graphite), ink (e.g., a pen or marker), or a combination thereof. As such, a user can manually draw an image onto the image receptive coating, and then transfer the image to a substrate.

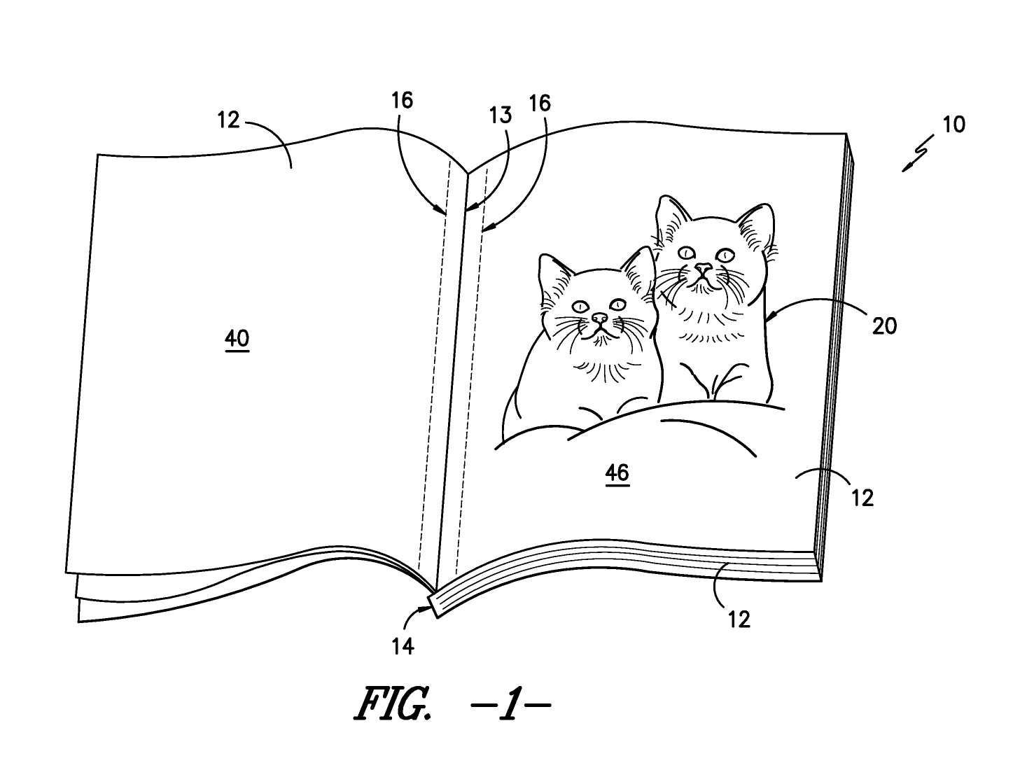

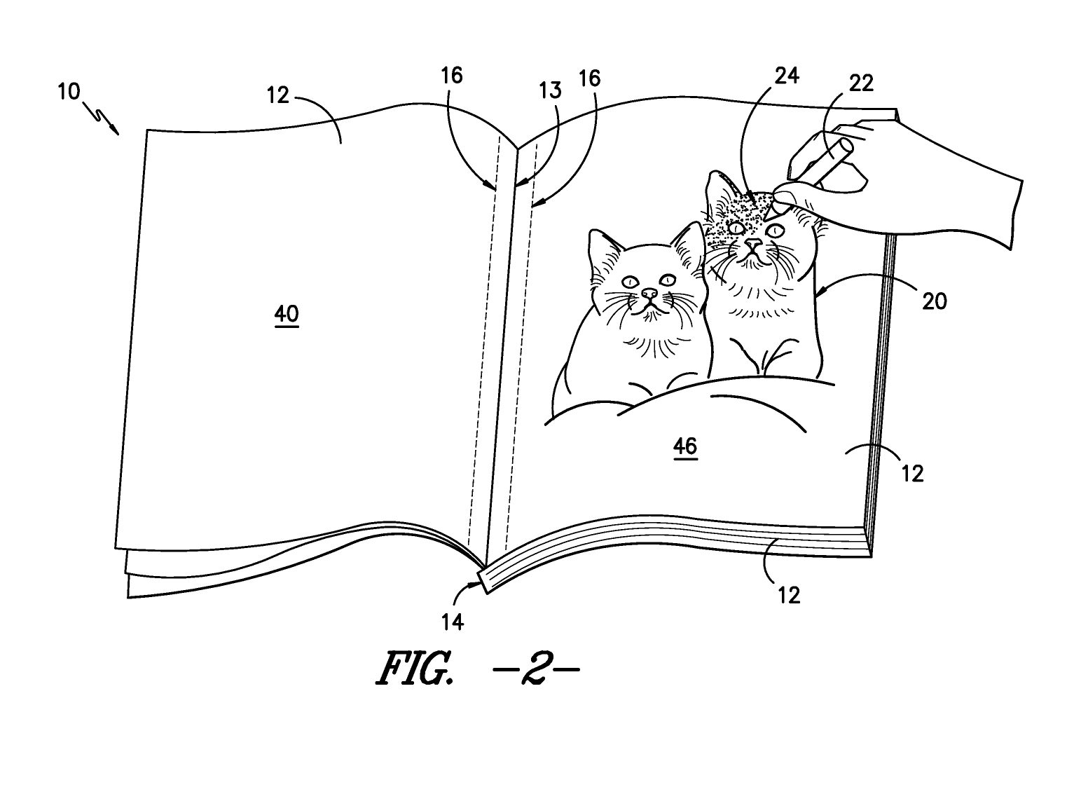

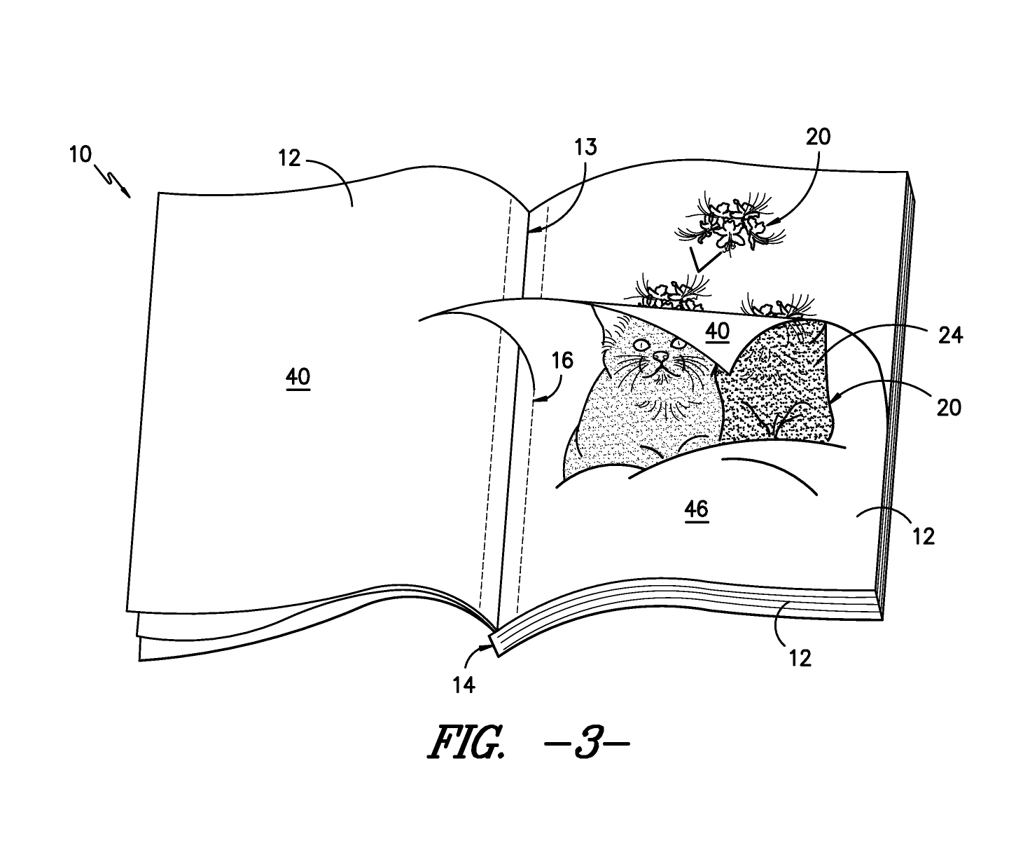

An exemplary coloring book 10 is shown in FIGS. 1-3. As shown, the coloring book 10 includes a plurality of heat transfer sheets 12 bound together along a common edge 14. For example, the plurality of heat transfer sheets 12 can be bound together via a binder or other adhesive material applied between adjacent sheets along the common edge 14 and/or proximate to the common edge 14. As used herein, the term “common edge” refers to the orientation of each edge 13 of the individual heat transfer sheets 12 in a substantially parallel manner.

As discussed in greater below, each heat transfer sheet 12 has an image-receptive coating 46 defining its exposed surface. In certain embodiments, a colored pattern 20 is present (i.e., pre-printed) on or in the image-receptive coating 46. For example, the colored pattern 20 can be present on a transferable layer of the heat transfer sheet 12 (e.g., the image-receptive coating 46 and/or the heat transfer layer) such that the colored pattern 20 transfers to the substrate with the applied image. Alternatively, the colored pattern 20 can be on a non-transferable layer of the heat transfer sheet 12 (e.g., the base sheet 40) such that the colored pattern 20 is not transferred to the substrate with the transferable layers.

As stated, a user can manually apply an image onto the image-receptive coating 46 of a heat transfer sheet 12 via a writing instrument 22. For example, the user can manually apply a colored wax (e.g., utilizing a crayon), an ink (eg., utilizing a marker, a pen, etc.), or the like to form the image 24.

After forming the image 24, the user can then remove a single heat transfer sheet 12 from the book 10. As shown, each heat transfer sheet 12 defines a perforation line 16 proximate to the common edge 14, which allows for the user to tear the heat transfer sheet 12 along the perforation line 16 to remove the sheet 12 from the book 10.

Particularly suitable heat transfer sheets are described in U.S. Pat. No. 6,916,751 of Kronzer, U.S. Pat. No. 7,238,410 of Kronzer, U.S. Pat. No. 7,361,247 of Kronzer, U.S. Pat. No. 7,364,636 of Kronzer, U.S. Pat. No. 7,604,856 of Kronzer, U.S. Pat. No. 8,172,974 of Kronzer, U.S. Pat. No. 8,236,122 of Kronzer; all of which are incorporated by reference herein.

Although not required, each heat transfer sheet 12 in the coloring book can, in one particular embodiment, have a substantially identical construction and composition.

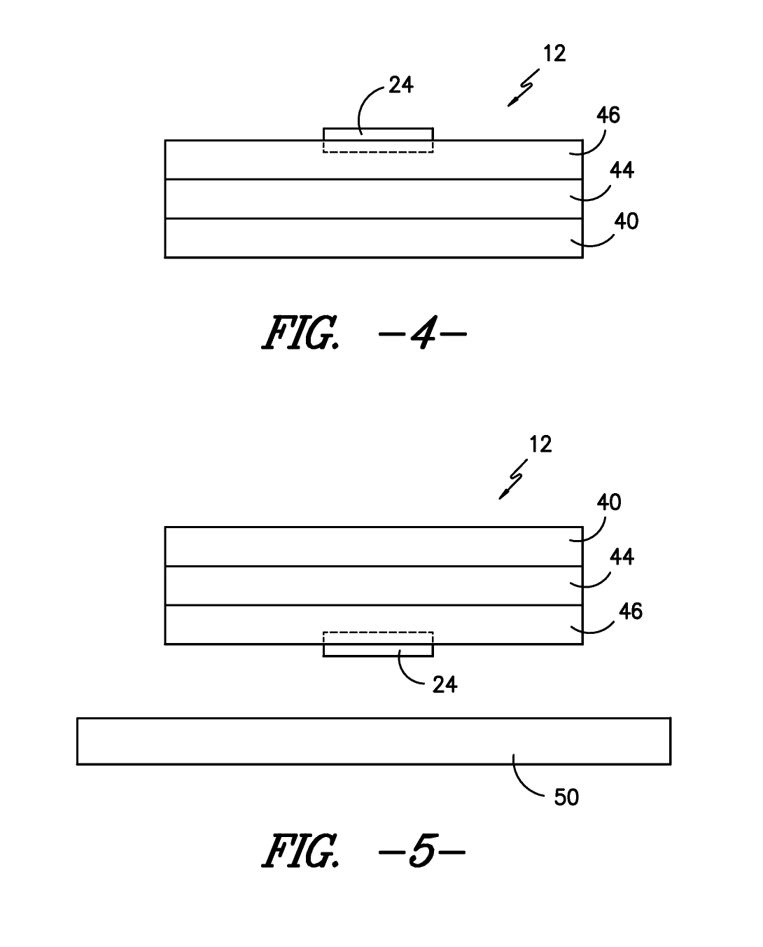

For example, referring to FIG. 4, one exemplary heat transfer sheet 12 is shown including an image-receptive coating 46 on heat transfer layer 44 on a base sheet 40. The image-receptive coating 46 generally defines an exposed surface of the heat transfer sheet 12. The base sheet 40 generally serves as the structural support for the transfer layers (i.e., the heat transfer layer 44 and the image-receptive coating 46).

As stated, the image-receptive coating 46 overlies a heat transfer layer 44 and a base sheet 40. In the exemplary embodiment shown, the image-receptive coating 46 is adjacent to and directly overlies the heat transfer layer 44, without any intermediate layers. In turn, the heat transfer layer 44 is adjacent to and directly overlies the base sheet 40, also without any intermediate layers. However, in other embodiments, intermediate layers may be positioned between the image-receptive coating 46, the heat transfer layer 44, and/or the base sheet 40. For example, a conformable layer may be positioned between the base sheet 40 and heat transfer layer 44 to facilitate the contact between the heat transfer sheet 12 and the substrate 50 to which the image is to be transferred. An example of a suitable conformable layer is disclosed in U.S. Pat. No. 4,863,781 to Kronzer, the disclosure of which is incorporated by reference.

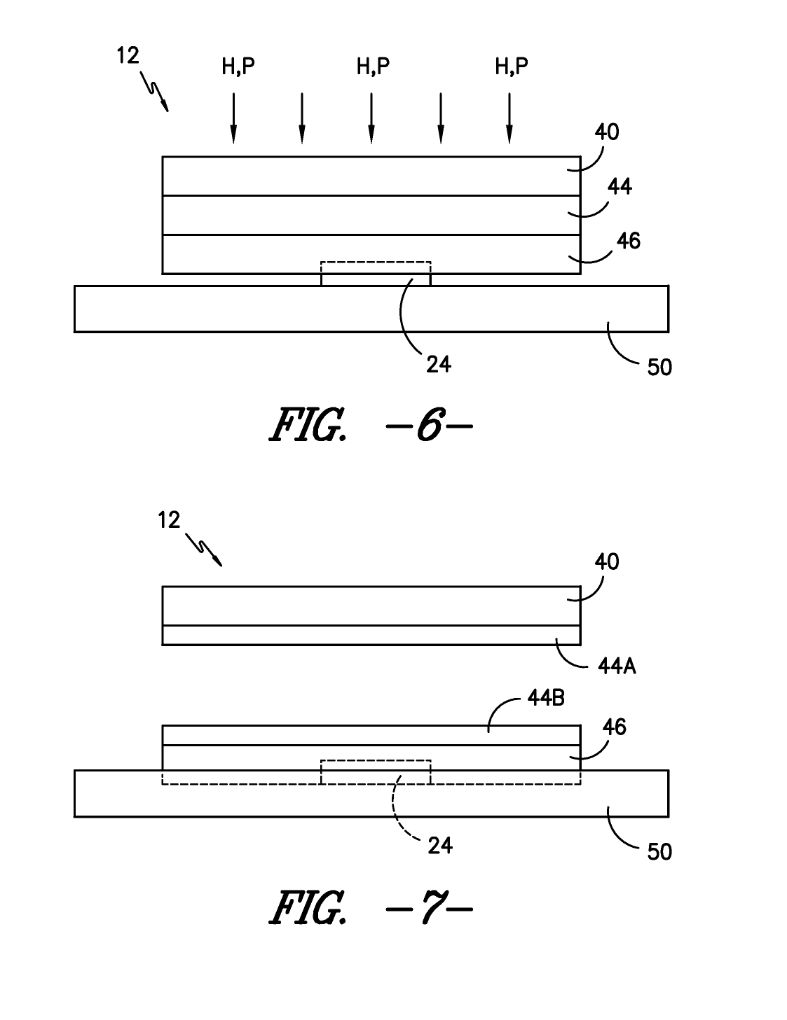

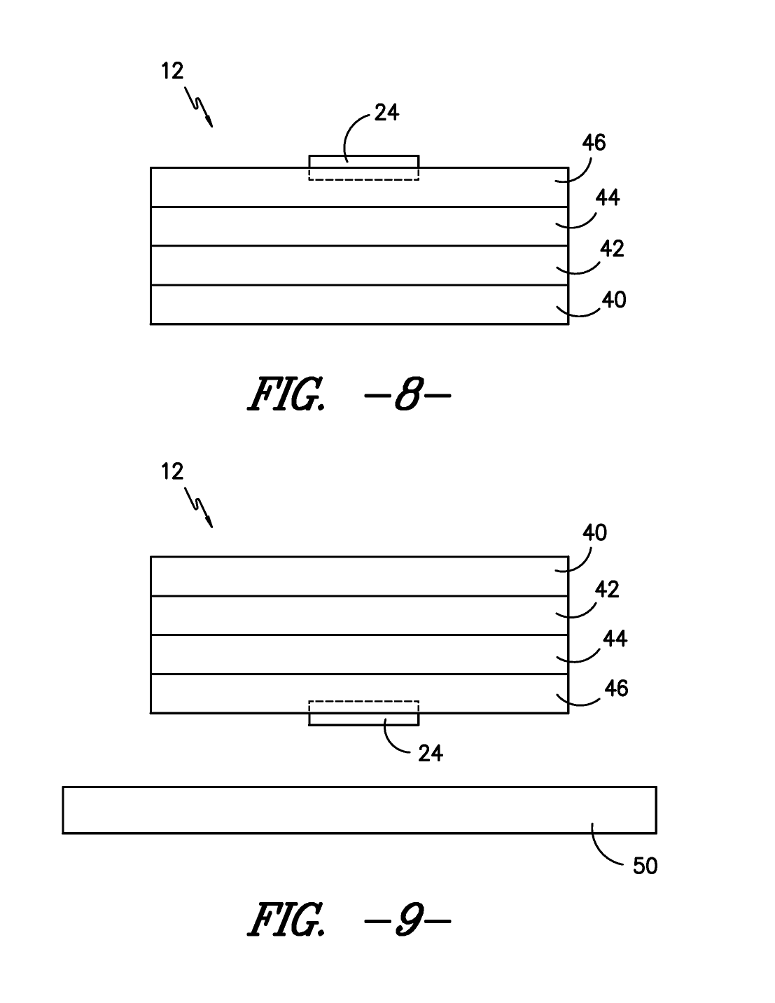

The heat transfer sheet 12 of FIG. 4 can be utilized to transfer an image 24 applied to its image-receptive coating 46 according to the heat transfer method sequentially shown in FIGS. 5-7. In FIG. 4, the image 24 is positively defined on the image-receptive coating 46, with the remainder of the surface area of the image-receptive coating 46 being substantially free of any colorant. According to this transfer method, the image 24 is a mirror image of the resulting image applied to the final substrate 50. However, other transfer methods can be utilized such that the resulting image applied to the substrate 50 is substantially identical in orientation to the image 24 of the heat transfer sheet 12 (i.e., not a mirror image).

After the image 24 has been applied onto the image-receptive coating 46, the heat transfer sheet 12 is positioned adjacent to a substrate 50. The heat transfer sheet 12 is positioned such that the image-receptive coating 46 and the image 24 are adjacent to the substrate 50, as shown in FIG. 5. The substrate 50 can be any surface to which the image 24 is to be transferred (e.g., a fabric cloth, nonwoven web, film, or any other surface). Desirable substrates 50 include porous surfaces, such as, for example, fabrics (e.g., a 100% cotton T-shirt material), and so forth.

Heat (H) and pressure (P) are then applied to the exposed base sheet 40 of the heat transfer sheet 12 adjacent to the substrate 50, as shown in FIG. 6. The heat (H) and pressure (P) can be applied to the heat transfer sheet 12 via a heat press, an iron (e.g., a conventional hand iron), etc. The heat (H) and pressure (P) can be applied to the heat transfer sheet 12 for a time sufficient to cause the image-receptive coating 46 and the heat transfer layer 44 to soften and melt. Temperatures at the transfer can be from about 150° C. or greater, such as from about 150° C. to about 350° C., and can be applied for a period of a few seconds to a few minutes (e.g., from about 5 seconds to about 5 minutes).

At the transfer temperature, both the image-receptive coating 46 and the heat transfer layer 44 soften and melt. The image-receptive coating 46 softens and flows directly onto or into the substrate 50. Once the heat (H) and pressure (P) are removed from the heat transfer sheet 12, the base sheet 40 is removed before the heat transfer sheet 12 can substantially cool (i.e., while the heat transfer sheet 12 is still hot). Removing the base sheet occurs by separating the heat transfer layer 44. A first portion (44A) of the heat transfer layer 44 remains on the base sheet 40 and is removed from the substrate 50, while a second portion (44B) of the heat transfer layer 44 is transferred to the substrate 50 along with the image-receptive coating 46. This process is an example of a hot peelable transfer process. As used herein, the phrase “hot peelable transfer process” refers to a process wherein one or more meltable layers is still in a molten state when a non-transferable portion of a heat transfer sheet is removed. Such a process allows release of the heat transfer sheet 12 via splitting of the meltable layer(s). Particularly suitable heat transfer sheets 12 having a splittable heat transfer layer 44, and their method of use, are disclosed in U.S. Pat. No. 7,887,667 entitled “Heat Transfer Materials and Methods of Making and Using the Same” issued Feb. 15, 2011 to Russell Dolsey, which is incorporated by reference herein.

Alternatively, a “cold peel” heat transfer process can be utilized after the heat transfer sheet 12. For example, U.S. Pat. No. 6,200,668 titled “Printable heat transfer material having cold release properties”; U.S. Pat. No. 6,113,725 titled “Printable heat transfer material having cold release properties”; and U.S. Pat. No. 5,798,179 titled “Printable heat transfer material having cold release properties” disclose suitable cold transfer sheets and methods, and are incorporated by reference herein.

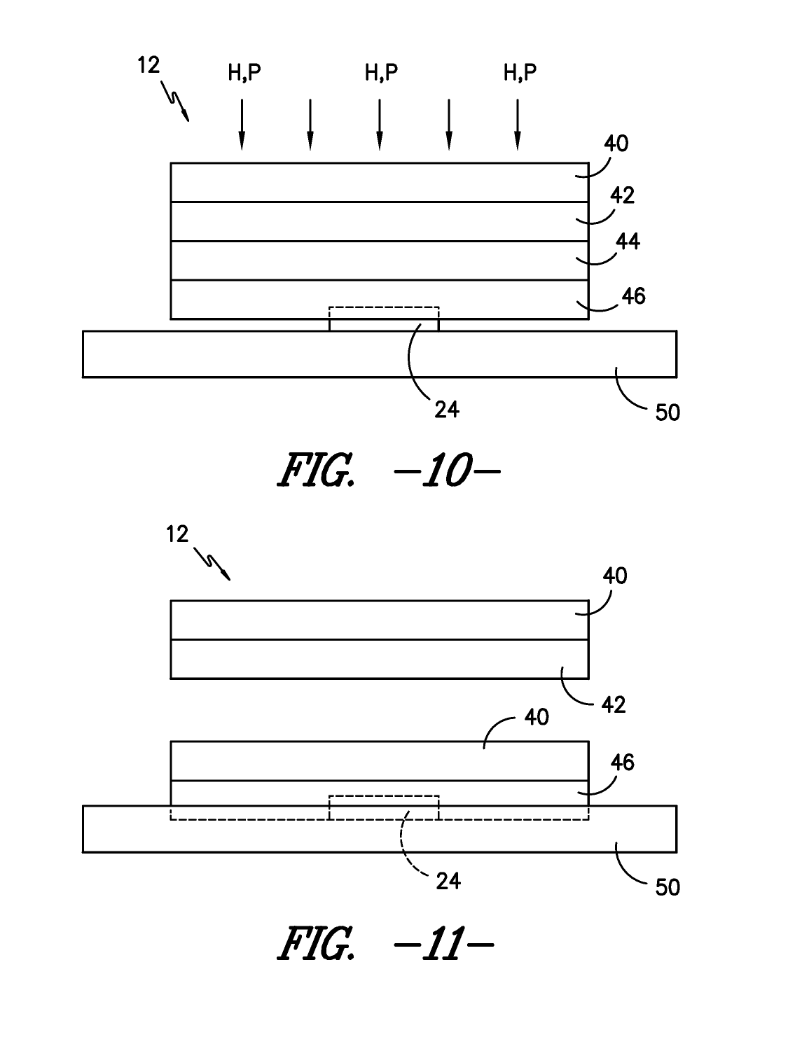

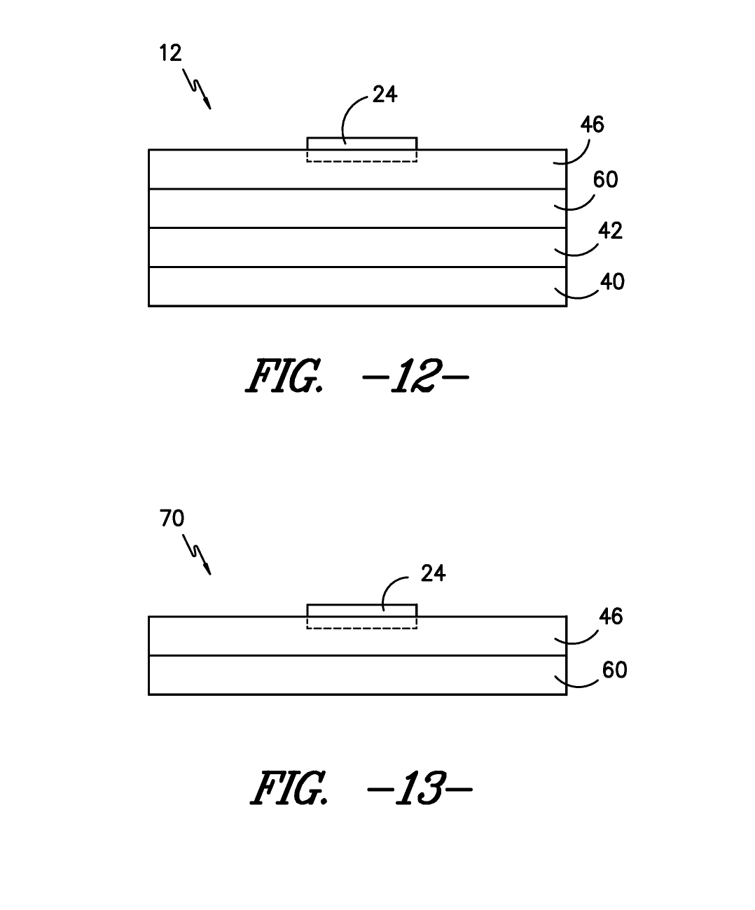

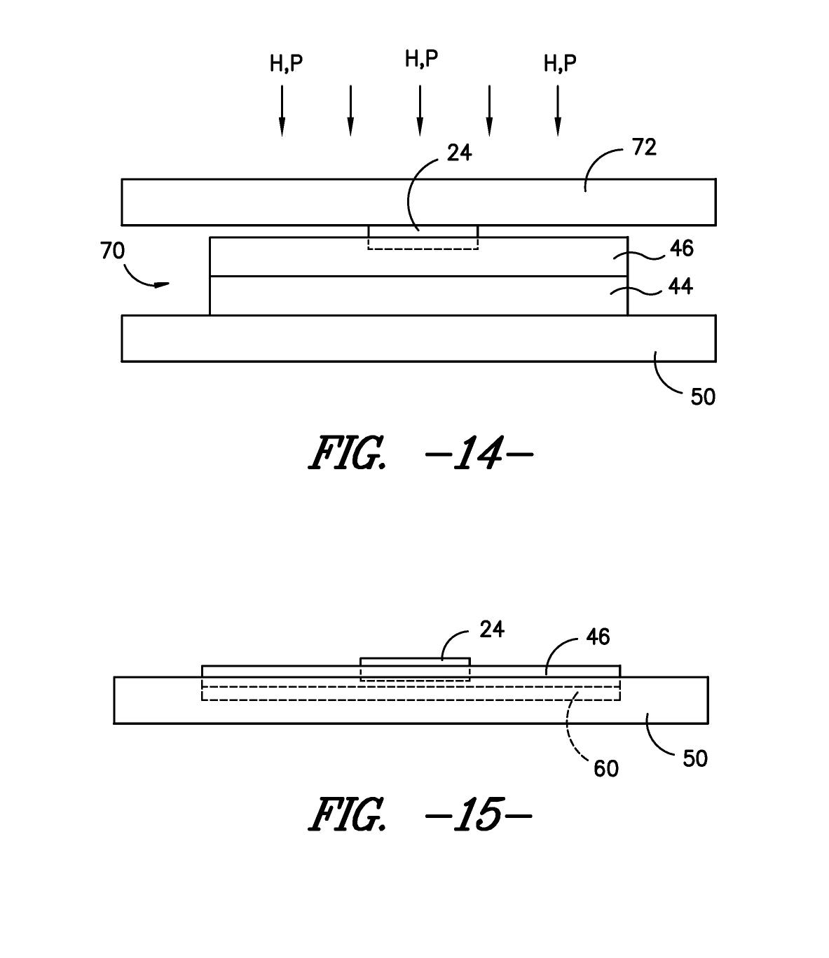

In such an embodiment, a release layer 42 can be included within the construction of the heat transfer sheet 12 between the base sheet 40 and the heat transfer layer 44, as shown in FIG. 8. Such a release layer 42 allows for the heat transfer layer 44 to be peeled from the base sheet 40 after transfer to the substrate 50. FIGS. 9-11 sequentially show such a transfer method similar to that described above with reference to FIGS. 5-7, except that upon peeling, substantially all of the heat transfer layer 44 remains on the substrate 50 due to the presence of the release layer 42 on the base sheet 40.

Thus, in these embodiments, the image-receptive coating 46 and at least a portion of the heat transfer layer 44 are configured to transfer to a substrate 50 upon application of heat and pressure, along with the image 24. Additionally, in these embodiments, the image 24 is coated on the substrate 50 to help provide durability to the image 24.

In another embodiment, a peelable heat transfer sheet 12 can be utilized, such as disclosed by U.S. Pat. No. 7,364,636 of Kronzer, which is incorporated by reference herein. FIG. 12 shows an exemplary peelable heat transfer sheet 12 that includes a peelable film layer 60 (serving as the heat transfer layer in this embodiment) on the release layer 42 and the base sheet 40, with the image-receptive coating 46 over the peelable film layer 60. After formation of an image 24 of the image-receptive coating 46, the peelable film layer 60 can be separated (e.g., peeled) from the base sheet 40 due to the properties of the release layer 42 to form an peeled intermediate sheet 70, as shown in FIG. 13.

The peeled intermediate sheet 70 can then be posited on a substrate 50 with the peelable film layer 60 adjacent to the substrate 50 and the image 24 exposed, and a parchment paper 72 or other release paper is positioned over the image, as shown in FIG. 14. Heat (H) and pressure (P) is then applied, and the parchment paper 72 is removed. After transfer, the parchment paper 72 is removed (e.g., after cooling, in a cold peel step), and the peelable film layer 60, the image-receptive coating 46, and the image 24 remains on the substrate 50. In this particular embodiment, the image 24 transferred to the substrate 50 is the identical image to that formed on the heat transfer sheet 12 (i.e., is not a mirror-image). Additionally, if desired, designs can be cut out of the heat transfer sheet 12 (either before or after peeling) prior to transfer.

In this embodiment, a plurality of parchment papers (or other release papers) can also be bound with the plurality of heat transfer sheets 12 along the common edge 14. Similar to the heat transfer sheets 12, each parchment paper can also define a perforation line proximate to the common edge such that the parchment papers can be removed from the book 10 to transfer the image 24 to the substrate 50.

These and other modifications and variations to the present invention may be practiced by those of ordinary skill in the art, without departing from the spirit and scope of the present invention, which is more particularly set forth in the appended claims. In addition, it should be understood the aspects of the various embodiments may be interchanged both in whole or in part. Furthermore, those of ordinary skill in the art will appreciate that the foregoing description is by way of example only, and is not intended to limit the invention so further described in the appended claims.

What is claimed:

1. A method of transferring an image to a substrate, the method comprising:
applying an image onto an image-receptive coating of a heat transfer sheet, wherein the heat transfer sheet further comprises a heat transfer layer overlying a base sheet such that the image-receptive coating overlies the heat transfer layer;
tearing the heat transfer sheet substantially along a perforation line to remove the heat transfer sheet from a coloring book;
positioning the heat transfer sheet adjacent onto a substrate; and
transferring the image, the image-receptive coating, and at least a portion of the heat transfer layer to the substrate, wherein the base sheet does not transfer to the substrate.

2. The method as in claim 1, wherein transferring comprises:
applying heat and pressure to the base sheet of the heat transfer sheet to transfer the image, the image-receptive coating, and at least the portion of the heat transfer layer to the substrate; and
removing the base sheet from the substrate leaving the image, the image-receptive coating, and at least the portion of the heat transfer layer on the substrate.

3. The method as in claim 1, wherein the image is applied onto the image-receptive coating manually by the user.

4. The method as in claim 3, wherein the image is applied onto the image-receptive coating with a crayon.

5. The method as in claim 4, wherein the crayon comprises a colored wax.

6. The method as in claim 3, wherein the image is applied onto the image-receptive coating as an ink.

7. The method as in claim 1, wherein the coloring book comprises a plurality of heat transfer sheets bound together along a common edge, each heat transfer sheet defining a perforation line proximate to the common edge.

8. The method as in claim 1, wherein a pre-design is present on or in the heat transfer sheet.

9. The method as in claim 8, wherein the pre-design is transferred to the substrate.

10. The method as in claim 8, wherein the pre-design is not transferred to the substrate.

11. The method as in claim 1, wherein the heat transfer layer is a splittable layer.

12. The method as in claim 1, wherein the heat transfer layer is a peelable film layer, and wherein a release layer is present between the peelable film layer and the base sheet.

13. The method as in claim 12, wherein transferring the image, the image-receptive coating, and at least a portion of the heat transfer layer to the substrate comprises:
peeling the peelable film layer from the base sheet;
positioning the peelable film layer adjacent to the substrate such that the image is exposed;
positioning a release paper over the image;
applying heat and pressure to the release paper to transfer the image, the image-receptive coating, and the peelable film layer to the substrate; and
removing the release paper from the substrate leaving the image, the image-receptive coating, and the peelable film layer on the substrate.

14. The method as in claim 1, wherein the substrate comprises a woven fabric.

15. The method as in claim 14, wherein the woven fabric comprises cotton fibers.

16. A coloring book comprising a plurality of heat transfer sheets bound together along a common edge, each heat transfer sheet defining a perforation line proximate to the common edge, wherein each heat transfer sheet comprises a base sheet, a heat transfer layer on the base sheet, and an image-receptive coating on the heat transfer layer, and wherein the image-receptive coating and at least a portion of the heat transfer layer are configured to transfer to a substrate upon application of heat and pressure.

17. The coloring book as in claim 15, wherein a colored pattern is present in or on the image-receptive coating.

18. The coloring book as in claim 15, wherein the perforation line defines a plurality of slits oriented substantially parallel to the common edge.

19. The coloring book as in claim 16, further comprising:
a plurality of parchment papers bound with the plurality of heat transfer sheets along the common edge, wherein each parchment paper defines a perforation line proximate to the common edge.
